(19) United States
(12) Patent Application Publication
(10) Pub. No.: US 2022/0378243 A1
(43) Pub. Date: Dec. 1, 2022

(54) Carafe, and Related Systems and Methods

(71) Applicant: MiiR Holdings, LLC, Seattle, WA (US)

(72) Inventors: Bryan Pape, Seattle, WA (US); Joe Gray, Seattle, WA (US)

(73) Assignee: MiiR Holdings, LLC, Seattle, WA (US)

(21) Appl. No.: 17/771,766

(22) PCT Filed: Oct. 22, 2020
(86) PCT No.: PCT/US2020/056850

§ 371 Date: Apr. 25, 2022

Related U.S. Application Data
(60) Provisional application No. 62/925,564, filed on Oct. 24, 2019.

(51) Int. Cl. A47J 31/02; A23F 5/26

(52) U.S. Cl. CPC A47J 31/02; A23F 5/262

(57) ABSTRACT

A carafe for holding a liquid includes a body having a cavity that is operable to hold a liquid, and a vent that allows fluid, such as air, to flow out of the cavity to the ambient environment, and from the ambient environment into the cavity, while liquid flows into and out of the cavity. The cavity has a mouth through which liquid flows when the liquid flows into the cavity and out of the cavity. The vent includes a passage that extends into the cavity of the body and has a first opening at a first end of the passage, a second opening at a second end of the passage. The passage's first opening is located in the cavity, the passage's second opening is located at the cavity's mouth. The passage is configured such that only the first opening and the second opening allow fluid access into the passage, and air inside of the cavity flows out of the cavity through the second opening when liquid flows into the cavity through the mouth.

### CROSS-REFERENCE TO RELATED APPLICATIONS AND INCORPORATION BY REFERENCE

This application claims priority from U.S. Provisional Patent Application 62/925,564 filed 24 Oct. 2019 and titled “Carafe, and Related Systems and Methods”. This application also incorporates by this reference the entirety of U.S. Provisional Patent Application 62/925,564.

### BACKGROUND

There are many different ways to make or brew coffee to drink. For example, one can use a French press that submerges coffee grounds in a container of hot water for a period and then isolates the grounds at the bottom of the container while one pours the coffee in a cup to drink. Or, one can force hot water under high pressure through coffee grounds in an espresso machine to pull a shot of coffee to drink. Or, one can simply pour hot water over coffee grounds held in a filter to drip coffee into a container or cup—pour-over method.

Of these three common techniques for making coffee, the easiest and quickest technique is the pour-over method. Using a French press requires a container and filter specifically designed for each other so that one can isolate the coffee grounds inside the container before pouring the coffee in a cup. Using an espresso machine requires substantial power to heat and then force under substantial pressure the water through the grounds. Because of this, the espresso machine is a specially designed machined that is bulky and not easily transportable. But, using the pour-over method simply involves a filter held by a holder or funnel and pouring hot water over coffee grounds in the filter to obtain drip coffee.

Unfortunately, it can be awkward when using a pour-over method. This is because the holder or funnel is typically placed on, and not fastened to, the top of the coffee cup or container that will receive the coffee. This means that the combination of the cup and the funnel become top-heavy and can be easily knocked over while one pours hot water onto the coffee grounds in the holder or funnel. This is especially true when the container is designed to hold more than one cup of coffee because such containers typically have a high (greater than 1) aspect ratio—the length of their height divided by the length of their base—and are hollow and empty at the beginning of a brewing process. This means that when the holder or funnel is placed on top of the container, and coffee grounds and water are held in the funnel, a significant amount of weight is suspended high above the base of the container. This lack of stability can be frustrating when one inadvertently knocks over the container and funnel, and/or dangerous if the funnel is knocked over when it is full of hot water.

Thus, there is a need for a container that provides greater stability when brewing coffee using a pour-over method.

### SUMMARY

In one aspect of the invention, a carafe for holding a liquid includes a body having a cavity that is operable to hold a liquid, and a vent that allows fluid, such as air, to flow out of the cavity to the ambient environment, and from the ambient environment into the cavity, while liquid flows into and out of the cavity. The cavity has a mouth through which liquid flows when the liquid flows into the cavity and out of the cavity. The vent includes a passage that extends into the cavity of the body and has a first opening at a first end of the passage, and a second opening at a second end of the passage. The passage's first opening is located in the cavity, the passage's second opening is located at the cavity's mouth. The passage is configured such that only the first opening and the second opening allow fluid access into the passage, and air inside of the cavity flows out of the cavity through the second opening when liquid flows into the cavity through the mouth.

With the carafe's vent, a coffee filter with coffee grounds in the filter can be held in the carafe's cavity while one pours hot water over the grounds to brew coffee. This reduces the aspect ratio of the carafe and pour-over funnel combination when using the pour-over method with the carafe by eliminating the need for a pour-over funnel located on top of the carafe. This, in turn, increases the stability of the carafe while brewing coffee using the pour-over method. The vent allows this to happen by allowing fluid in the carafe's cavity to escape the cavity as freshly brewed coffee enters the cavity. Thus, the coffee filter and coffee grounds can be held in the cavity at and/or near the cavity's mouth, which plugs the cavity's mouth and prevents fluid inside the cavity from escaping through the mouth. In addition, the vent eliminates the need for a pour-over funnel to hold the coffee filter and coffee grounds while pouring hot water over the grounds because the carafe's body can now provide this function. Also, the vent allows fluid, such as ambient air, located outside the carafe to flow into the carafe's cavity unobstructed while liquid flows out of the carafe's cavity so that the flow of the liquid out of the cavity can be easily maintained at a constant flow rate.

In another aspect of the invention, a method for brewing coffee includes: a) holding a coffee filter in a mouth of a cavity of a carafe's body; b) holding coffee grounds in the coffee filter; c) pouring water onto the coffee grounds; d) generating coffee by allowing the water to flow through the coffee grounds and the coffee filter, while preventing the coffee grounds from passing through the filter; e) catching the coffee in the cavity of the carafe's body; and f) directing, through a passage of a vent, air inside the cavity toward the ambient environment outside of the carafe's body while the coffee flows into the cavity.

### BRIEF DESCRIPTION OF THE DRAWINGS

FIG. 1 shows a perspective view of a carafe, according to an embodiment of the invention.

FIG. 2 shows an exploded view of the carafe shown in FIG. 1, according to an embodiment of the invention.

FIG. 3 shows a cross-sectional view of the carafe shown in FIG. 1, according to an embodiment of the invention.

FIG. 4 shows a cross-sectional view of a portion of the carafe shown in FIG. 1 with a coffee filter and coffee grounds held in a portion of the carafe, according to an embodiment of the invention.

FIG. 5 shows a different perspective view of a portion of the carafe shown in FIG. 1, according to an embodiment of the invention.

### DETAILED DESCRIPTION

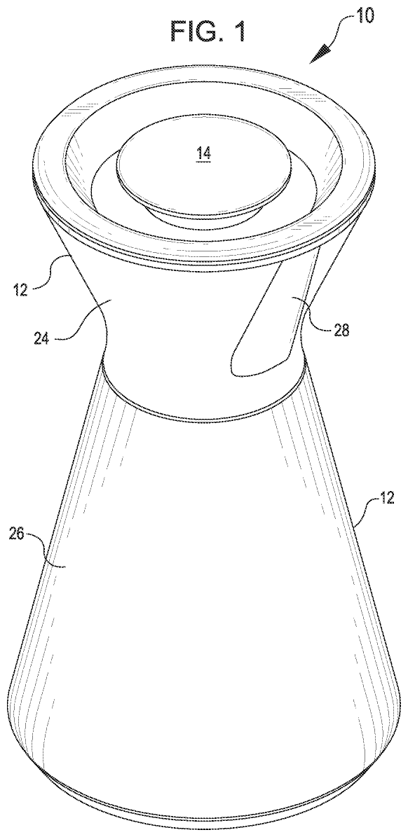

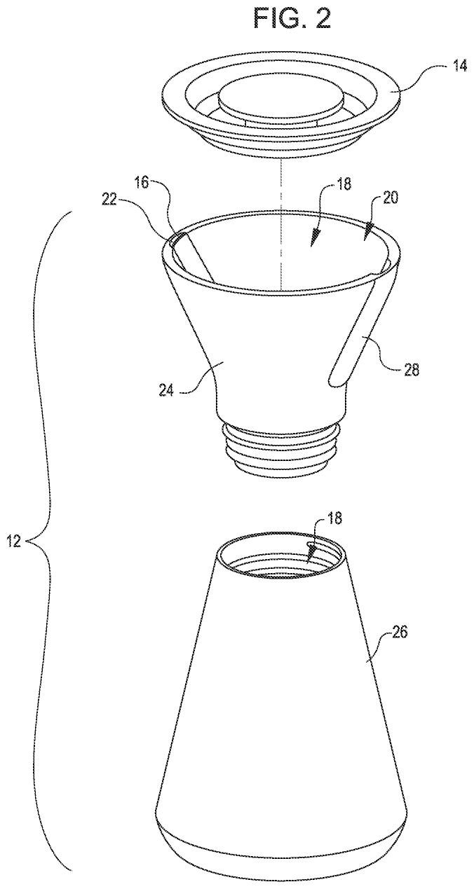

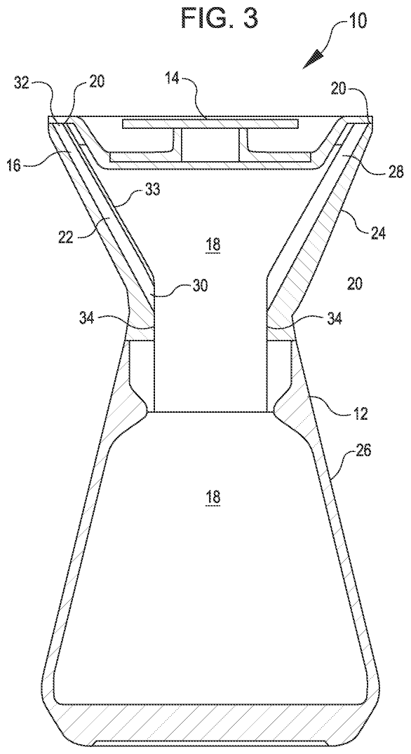

FIG. 1 shows a perspective view of a carafe 10, according to an embodiment of the invention. FIG. 2 shows an exploded view of the carafe 10 shown in FIG. 1, according to an embodiment of the invention. The carafe 10 includes a body 12, a lid 14, and a vent 16 (shown in FIG. 2; also shown in FIGS. 3-5 and discussed in greater detail in conjunction with these FIGS. 3-5). The body 12 includes a cavity 18 (FIG. 2) that can hold a liquid, such as coffee or water, and that has a mouth 20 (FIG. 2) through which liquid flows when liquid flows into and out of the cavity 18. Here, liquid does not include a gas, such as air; and fluid includes both a liquid and/or a gas. The lid 14 is releasably coupleable with the body 12. When the lid 14 is coupled with the body 12, the lid 14 covers the mouth 20 of the cavity 18 and prevents liquid from flowing into and/or out of the cavity 18. When the lid 14 is not coupled with the body 12, the lid 14 does not cover the mouth 20, and liquid is allowed to flow into and out of the body's cavity 18. The vent 16 (FIG. 2) includes a passage 22 (FIG. 2) that extends into the cavity 18 and allows fluid, such as air, to flow out of and into the cavity 18 while liquid flows into and out of the cavity 18, respectively.

With the carafe's vent 16, a coffee filter with coffee grounds in the filter can be held in the carafe's cavity 18 while one pours hot water over the grounds to brew coffee. This reduces the aspect ratio of the carafe 10 and pour-over funnel combination when using the pour-over method with the carafe 10 by eliminating the need for a pour-over funnel located on top of the carafe 10, above the mouth 20. This, in turn, increases the stability of the carafe 10 while brewing coffee using the pour-over method. The vent 16 allows this to happen by allowing fluid in the carafe's cavity 18 to escape the cavity 18 via the vent's passage 22 as freshly brewed coffee enters the cavity 18. Thus, the coffee filter and coffee grounds can be held in the cavity 18 at and/or near the cavity's mouth 20, which plugs the cavity's mouth 20 and prevents fluid inside the cavity 18 from escaping through the mouth 20. In addition, the vent 16 eliminates the need for a pour-over funnel to hold the coffee filter and coffee grounds while pouring hot water over the grounds because the carafe's body 12 can now provide this function. Also, the vent 16 allows fluid, such as ambient air, located outside the carafe 10 to flow into the carafe's cavity 18 unobstructed while liquid flows out of the carafe's cavity 18 so that the flow of the liquid out of the cavity 18 can be easily maintained at a constant flow rate.

The body 12 may be sized and configured as desired. For example, in this and other embodiments the body 12 includes a first portion 24 and a second portion 26. The first and second portions 24 and 26, respectively, are releasably coupleable with each other. More specifically, each of the portions 24 and 26 include threads that are sized and configured to engage each other to couple each of the portions 24 and 26 with the other. Each of the portions 24 and 26 also have a truncated conical shape with their respective threads located at the narrower end of the conical shape. In this configuration, when the first and second portions 24 and 26, respectively, are coupled together to form the whole body 12, the whole body 12 has an hour-glass shape. In this configuration, the body's first portion 24 includes the cavity's mouth 20, and can hold a coffee filter with coffee grounds in the filter while one pours hot water over the grounds to brew coffee. The brewed coffee can then flow from the body's first portion 24 into the cavity 18 in the body's second portion 26. Each of the body portions 24 and 26 also includes a double-walled construction in which an inner wall defines the cavity 18, and an outer wall surrounds the inner wall and defines a region between the two walls that can insulate the cavity 18.

Other embodiments are possible. For example, body 12 may be a single solid piece, or the body 12 may include more than two portions that are combined together to form a whole body 12. For another example, the body 12 may have any other desired geometric shape, such as a cylinder. Also, the body 12 may not include a double-walled construction, but rather a single wall construction in which the single wall defines the cavity 18 inside the body 12 and is also exposed to the environment outside of the body 12.

Still referring to FIGS. 1 and 2, the cavity 18 may also be configured as desired. For example, in this and other embodiments the cavity 18 has a shape that mimics the shape of the body 12. More specifically, the cavity 18 has an hour-glass shape formed by the intersection of two truncated conical shapes at each of their narrow ends. In this configuration, the cavity 18 extends into both of the body's first portion 24 and second portion 26, and the portion of the cavity 18 that extends into the body's first portion 24 includes the mouth 20. In this configuration, the portion of the cavity 18 in the body's first portion 24 can hold a coffee filter with coffee grounds in it while one pours hot water over the grounds to brew coffee via a pour-over method. The brewed coffee then falls into the portion of the cavity 18 in the body's second portion 26, while the coffee grounds remain with the coffee filter in the portion of the cavity 18 in the body's first portion 24.

Other embodiments are possible. For example, the cavity 18 may not mimic the shape of the body 12. In such embodiments, the cavity 18 may be substantially smaller in volume than the body 12.

Still referring to FIGS. 1 and 2, the body 12 may also include a spout 28 that is sized and configured as desired to direct liquid flowing out of the cavity 18 in a consistent direction. For example, in this and other embodiments the spout 28 includes a U-shaped channel that extends from the mouth 20 into the cavity 18. In other embodiments, the spout 28 may extend beyond the mouth 20 and may not be a channel but rather a conduit that has circular cross-section.

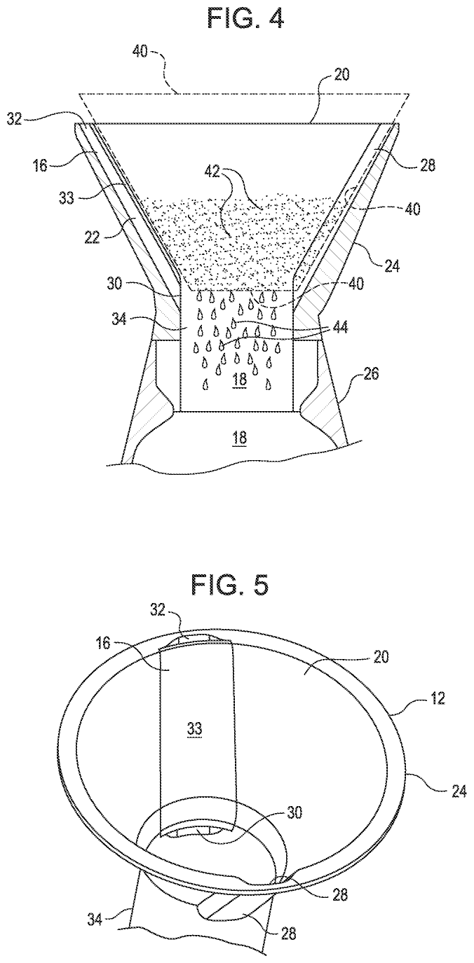

Each of FIGS. 3, 4 and 5, shows a different view of the carafe 10 shown in FIGS. 1 and 2, each according to an embodiment of the invention. FIG. 3 shows a cross-sectional view of the carafe 10 shown. FIG. 4 shows a cross-sectional view of a portion of the carafe 10 with a coffee filter and coffee grounds held in the portion of the carafe 10. And, FIG. 5 shows a different perspective view of a portion of the carafe 10.

As previously mentioned, the vent 16 includes a passage 22 that extends into the cavity 18 and allows fluid, such as air, to flow out of and into the cavity 18 while liquid flows into and out of the cavity 18, respectively. The vent 16 may be configured as desired. For example, in this and other embodiments the vent 16 includes a first opening 30 located in the cavity 18, a second opening 32 located at the cavity's mouth 20, and the passage 22 extends from the first opening to the second opening. The passage 22 is formed by a U-shaped channel in the body's first portion 24 and a cover 33 that is coupled to the first portion 24 and caps the U-shaped channel. In this manner the vent 16 can be easily converted into a spout 28 if an additional spout is desired. The vent 16 is configured such that any fluid that enters the passage 22 must enter through either the first opening 30 or the second opening 32. In this configuration, fluid inside the passage 22 is isolated from the cavity 22 except via the first opening 30, and isolated from the ambient air outside of the carafe's body's 12 except via the second opening 32. This allows fluid flowing to and from the cavity 18 to flow without interference from liquid flowing through the cavity's mouth 20.

The vent 16 may extend any desired length into the cavity 18. For example, in this and other embodiments the vent 16 extends to the throat 34. In this configuration, the vent 16 remains wholly disposed in the body's first portion 24. This allows the first and second portions 24 and 26, respectively, to be releasably couple with each other without regard to their relative position (in the rotational sense) to each other. In other embodiments, especially ones that include a single-piece body 12, the vent 16 may easily extend deeper into the cavity 18 to better facilitate the flow of a fluid such as ambient air into the cavity 18 while liquid flows out of the cavity 18 through the mouth 20. This allows one to easily maintain at a constant flow rate the flow of a liquid out of the cavity 18.

The vent 16 may be located as desired. For example, in this and other embodiments the vent 16 is located opposite the spout 28. More specifically, the vent 16 is located diametrically opposite the spout 28 in the first portion 24 of the carafe's body 12. In this configuration, liquid flowing out of the cavity 18 via the spout 28 is not likely to also flow through vent 16 and be directed toward a location other than the desired location, such as one's cup, that the spout 28 directs liquid toward. In other embodiments, the vent 16 may be located closer to the spout 28.

Other embodiments are possible. For example, the carafe 10 may include two or more vents 16 that each provide the same function—fluid flow into the cavity 18 and/or fluid flow out of the cavity 18, as needed. Or, the carafe 10 may include a vent 16 that is specifically configured to allow fluid to easily flow out of the cavity 18 while liquid flows into the cavity 18 through the mouth 20, and another vent 16 that is specifically configured to allow fluid to easily flow into the cavity 18 while liquid flows out of the cavity 18.

As shown in FIG. 4, when the carafe 10 is used to brew coffee using a pour-over method, a coffee filter 40 is placed in the cavity 18 of the body's first portion 24. Coffee grounds 42 may then be placed in the filter 40. Hot water (not shown) is then poured over the coffee grounds 42. As the water flows through the grounds 42, the water dissolves and absorbs oils and other elements from the grounds to form coffee 44. The coffee 44 then leaves the grounds 42 and filter 40, and drops into the cavity 18 of the body's second portion 26.

The preceding discussion is presented to enable a person skilled in the art to make and use the invention. Various modifications to the embodiments will be readily apparent to those skilled in the art, and the generic principles herein may be applied to other embodiments and applications without departing from the spirit and scope of the present invention. Thus, the present invention is not intended to be limited to the embodiments shown, but is to be accorded the widest scope consistent with the principles and features disclosed herein.

What is claimed is:

1. A carafe for holding a liquid, the carafe comprising:
a body having a cavity that is operable to hold a liquid, the cavity having a mouth through which liquid flows when the liquid flows into the cavity and out of the cavity, and
a vent that includes a passage that extends into the cavity of the body and has:
a first opening at a first end of the passage,
a second opening at a second end of the passage, and
wherein the passage's first opening is located in the cavity, the passage's second opening is located at the cavity's mouth, and the passage is configured such that:
only the first opening and the second opening allow fluid access into the passage, and
air inside of the cavity flows out of the cavity through the second opening when liquid flows into the cavity through the mouth.

2. The carafe of claim 1 wherein the cavity has a truncated conical shape.

3. The carafe of claim 1 wherein the cavity has an hour-glass shape.

4. The carafe of claim 1 wherein the mouth of the cavity is configured to receive a coffee filter with coffee grounds disposed in the filter for brewing coffee.

5. The carafe of claim 1 wherein:
the body's cavity extends into a first portion of the body and into a second portion of the body;
the first portion includes the mouth of the cavity, and is operable to hold a coffee filter with coffee grounds disposed in the filter while water is poured on the coffee grounds to brew coffee; and
the second portion is releasably couplable with the first portion, and operable to hold coffee brewed in the body's first portion.

6. The carafe of claim 1 wherein:
the body's cavity extends into a first portion of the body and into a second portion of the body;
the first portion includes the mouth of the cavity, and is operable to hold a coffee filter with coffee grounds disposed in the filter while water is poured on the coffee grounds to brew coffee;
the second portion is releasably couplable with the first portion, and operable to hold coffee brewed in the body's first portion;
the first opening of the vent's passage is located in the first portion of the body; and
the second opening of the vent's passage is also located in the first portion of the body.

7. The carafe of claim 1 wherein the body includes an inner wall that defines the cavity, and an outer wall that surrounds the inner wall and defines a region between the inner and outer walls that insulates the cavity.

8. The carafe of claim 1 wherein the body includes a spout operable to direct the liquid flowing out of the cavity in a consistent direction, the spout extending into the cavity from the cavity's mouth.

9. The carafe of claim 1 wherein the body includes a spout operable to direct the liquid flowing out of the cavity in a consistent direction, the spout extending into the cavity from the cavity's mouth, and the spout includes a U-shaped channel that extends from the cavity's mouth into the cavity.

10. The carafe of claim 1 wherein:
the body includes a spout operable to direct the liquid flowing out of the cavity in a consistent direction, the spout extending into the cavity from the cavity's mouth; and
the vent is located across the cavity's mouth from the spout.

11. A method for brewing coffee, the method comprising:
holding a coffee filter in a mouth of a cavity of a carafe's body;
holding coffee grounds in the coffee filter;
pouring water onto the coffee grounds;
generating coffee by allowing the water to flow through the coffee grounds and the coffee filter, while preventing the coffee grounds from passing through the filter;
catching the coffee in the cavity of the carafe's body; and
directing, through a passage of a vent, air inside the cavity toward the ambient environment outside of the carafe's body while the coffee flows into the cavity.

12. The method of claim 11 wherein directing air through the passage of the vent includes allowing the air to flow through a first opening of the vent's passage, wherein the first opening is located in the body's cavity.

13. The method of claim 10 wherein directing fluid in the ambient environment into the cavity of the carafe's body includes allowing the fluid to flow through a second opening of the vent's passage, wherein the second opening is located at the cavity's mouth.

14. The method of claim 10 further comprising insulating the cavity of the carafe's body.

15. The method of claim 11 further comprising pouring the coffee out of the body's cavity via a spout located in the cavity's mouth.

16. The method of claim 11 further comprising:
pouring the coffee out of the body's cavity via a spout located in the cavity's mouth; and
directing, through the passage of the vent, ambient air outside of the carafe's body toward the inside the cavity while the coffee flows out of the cavity.
